(19) United States
(12) Patent Application Publication
(10) Pub. No.: US 2022/0340276 A1
(43) Pub. Date: Oct. 27, 2022

(54) Drone Umbrella Device

(71) Applicant: Joseph Harris, Baltimore, MD (US)

(72) Inventor: Joseph Harris, Baltimore, MD (US)

(21) Appl. No.: 17/727,057

(22) Filed: Apr. 22, 2022

Related U.S. Application Data
(60) Provisional application No. 63/180,186, filed on Apr. 27, 2021.

(51) Int. Cl. B64C 39/02; B64D 27/24; B64D 47/00; A45B 9/02; A45B 11/00

(52) U.S. Cl. CPC B64C 39/024; B64D 27/24; B64D 47/00; A45B 9/02; A45B 11/00; B64C 2201/027; B64C 2201/042; B64C 2201/108; B64C 2201/146; A45B 2009/007

(57) ABSTRACT

The present invention relates generally to a drone umbrella device primarily comprised of an umbrella, at least one drone and a mobile application. The at least one drone is attached to the umbrella, such that the umbrella can hover over the top of a user. The umbrella is comprised of a telescoping handle assembly that has a detachable handle. The detachable handle has an internal GPS transmitter that communicates with a receiver on the drone, such that the drone follows the location of the detachable handle. In this manner, a user can retain the detachable handle, while the device hovers over the user as he or she sits, walks, runs, etc.

### CROSS-REFERENCE TO RELATED APPLICATION

The present application claims priority to, and the benefit of, U.S. Provisional Application No. 63/180,186 which was filed on Apr. 27, 2021 and is incorporated herein by reference in its entirety.

### FIELD OF THE INVENTION

The present invention relates generally to the field of umbrellas. More specifically, the present invention relates to a drone umbrella device primarily comprised of an umbrella, at least one drone and a mobile application. The at least one drone is attached to the umbrella such that the umbrella can hover over the top of a user. The umbrella is further comprised of a telescoping handle assembly that has a detachable handle. The handle has an internal GPS transmitter that communicates with a receiver of the drone, such that the drone follows the location of the handle. In this manner, a user can place the handle on his or her person and have the device hover over his or her person as he or she sits, walks, runs, etc. Accordingly, the present disclosure makes specific reference thereto. Nonetheless, it is to be appreciated that aspects of the present invention are also equally applicable to other like applications, devices and methods of manufacture.

### BACKGROUND

Umbrellas are regularly used to prevent an individual from getting rained on. However, umbrellas require at least one hand to hold during use. This is undesirable, as an umbrella user may need said hand to perform other tasks. In windy scenarios, a user may even be required to use two hands to hold an umbrella. In either scenario, a user cannot perform any task that requires two hands, as at least one hand must be holding the umbrella.

Therefore, there exists a long-felt need in the art for an improved umbrella device that allows a user to utilize the convenience of an umbrella without requiring a user to keep two hands on an umbrella during use. There also exists a long-felt need in the art for a drone umbrella device that does not require a user to keep any of his or her hands on an umbrella during use. Further, there exists a long-felt need in the art for a drone umbrella device that does not contact the body of a user or requires support from the body of a user, while providing a hands-free umbrella.

The subject matter disclosed and claimed herein, in one embodiment thereof, comprises a drone umbrella device. The device is primarily comprised of an umbrella, at least one drone and a mobile application. The at least one drone is attached to the umbrella, such that the umbrella can hover over the top of a user. The umbrella is further comprised of a telescoping handle assembly with a detachable handle. The handle has an internal GPS transmitter that communicates with a receiver of the drone, such that the drone follows the location of the handle. In this manner, a user can retain the handle on his or her person and have the device hover over the person as he or she sits, walks, runs, etc. In addition, the mobile application allows a user to configure various features of the drone.

In this manner, the drone umbrella device of the present invention accomplishes all of the forgoing objectives and provides an improved umbrella device that does not require a user to use two hands to use the device. Further, the device can be used hands-free by a user. In addition, the device does not rely on the body of the user to support the device while it is being used in a hands-free manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drone umbrella device. The device is primarily comprised of an umbrella, at least one drone and a mobile application. The umbrella is comprised of a reinforced body that is in the shape of a conventional umbrella and/or any other suitable umbrella shape known in the art. The body material is also preferably waterproof and/or water resistant. The inner surface of the body further comprises a handle assembly comprising a telescoping body. The first end of the telescoping body is fixedly or removably-attached to the inner surface of the umbrella. The second end of the telescoping body is further comprised of a handle that can be detached from the second end of the telescoping body. The handle further has a GPS transmitter and a battery that may be recharged via a USB port.

The outer surface of the umbrella is further comprised of at least one drone, wherein the drone is preferably a quad-copter style drone that has four rotors, with each rotor having a motor. The drone is further fixedly or removably-attached to the outer surface via at least one fastener. The drone also comprises a battery that can be recharged via a USB port.

When using the device, the drone lifts the umbrella off the ground, such that the umbrella hovers over the top of a user. The umbrella further follows the user and remains in a position above the user as he or she walks, runs, stands or sits. In order to maintain a position above the user as the user moves, the handle must be detached from the telescoping body and be retained by the user, such that the handle moves with the user. As a user moves with the detached handle, a transmitter within the handle communicates with a receiver within the drone via a communication means such as, but not limited to, RFID, Bluetooth, Cellular, Wi-Fi, etc. As a result, the drone will automatically position itself such that it is directly above the GPS location of the handle at all times.

A mobile application also allows a user to control various features of the drone by communicating with a processor of the drone via RFID, Bluetooth, Cellular, Wi-Fi, etc. One such feature is setting the speed of the drone, which can be used to allow the drone to more closely follow a user who is running or walking. This feature may also allow a user to set the drone to a run or walk mode. A user can also set the height in which the drone hovers over the handle and/or user, to control the height of the device in areas where the device must fit under obstacles or is too close to the body of a user. In addition, a user can set the drone to hover in a specific location and/or to follow the movement of the handle, such that the device can remain hovering in a single location when a user is not moving or can follow above the user as the user moves. In addition, the mobile application can be used by the drone to track the location of the user, to allow the drone to follow the user in lieu of or in addition to the handle.

Accordingly, the drone umbrella device of the present invention is particularly advantageous as it provides an improved umbrella device that does not require a user to use two hands to use the device. Further, the device is a hands-free device. In addition, the device does not rely on the body of the user to support the device in a hands-free manner during use. Therefore, the drone umbrella device overcomes the limitations of existing umbrellas known in the art and provides an umbrella-type device that is fully self-supported and hands-free.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the drone umbrella device of the present invention in accordance with the disclosed architecture;

FIG. 2 illustrates a perspective view of one potential embodiment of the drone umbrella device of the present invention disclosing the telescoping handle retracted upwards toward the umbrella in accordance with the disclosed architecture;

FIG. 3 illustrates a perspective view of one potential embodiment of the drone umbrella device of the present invention in use in accordance with the disclosed architecture; and

FIG. 4 illustrates a graphical view of the primary functions of the mobile application of one potential embodiment of the drone umbrella device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved umbrella device that allows a user to utilize the convenience of an umbrella without requiring a user to keep two hands on an umbrella during use. There also exists a long-felt need in the art for a drone umbrella device that is hands-free. Further, there exists a long-felt need in the art for a drone umbrella device that does not contact the body of a user or require support from the body of a user, while providing a hands-free umbrella.

The present invention, in one exemplary embodiment, is comprised of a drone umbrella device primarily comprised of an umbrella, at least one drone and a mobile application. The umbrella is comprised of a reinforced body that is in the shape of a conventional umbrella and/or any other suitable umbrella shape known in the art, and is preferably waterproof and/or water resistant. The inner surface of the body further comprises a handle assembly that has a telescoping body, wherein the first end of the telescoping body is fixedly or removably-attached to the inner surface of the umbrella. The second end of the telescoping body is further comprised of a handle that can be detached from the second end of the body, which also comprises a GPS transmitter and a battery that may be recharged via a USB port.

The outer surface of the umbrella is further comprised of at least one drone. The drone is preferably a quad-copter style drone that has four rotors, wherein each rotor has a motor. The drone is further fixedly or removably-attached to the outer surface via at least one fastener. The drone also has a battery that can be recharged via a USB port.

During operation, the drone lifts the umbrella off the ground, such that the umbrella hovers over the top of a user. The umbrella further follows the user and remains in a position above the user as he or she walks, runs, stands or sits. In order to maintain a position above the user as the user moves, the handle must be detached from the telescoping body and be retained by the user, such that the handle moves with the user. As a user moves with the detached handle, a transmitter on the handle communicates with a receiver on the drone via a communication means such as, but not limited to, RFID, Bluetooth, Cellular, Wi-Fi, etc. Accordingly, the drone will automatically position itself such that it is directly above the GPS location of the handle at all times.

A mobile application also allows a user to control various features of the drone by communicating with a processor within the drone via RFID, Bluetooth, Cellular, Wi-Fi, etc. The application allows a user to set the speed of the drone, which can be used to allow the drone to more closely follow a user who is running or walking. This feature may also allow a user to set the drone to a run or walk mode. A user can also set the height in which the drone hovers over the handle and/or user, to control the height of the device in areas where the device must fit under obstacles or is too close to the body of a user. Furthermore, a user can set the drone to hover in a specific location and/or to follow the movement of the handle, such that the device can remain hovering in a single location when a user is not moving or can follow above the user as the user moves. It should also be noted that the mobile application can be used by the drone to track the location of the user, to allow the drone to follow the user in lieu of or in addition to the handle.

Accordingly, the drone umbrella device of the present invention is particularly advantageous, as it provides an improved umbrella device that does not require a user to use two hands to use the device. Further, the device is a hands-free device. In addition, the device does not rely on the body of the user to support the device in a hands-free manner during use. Therefore, the drone umbrella device overcomes the limitations of existing umbrellas known in the art and provides an umbrella-type device that is fully self-supported and hands-free.

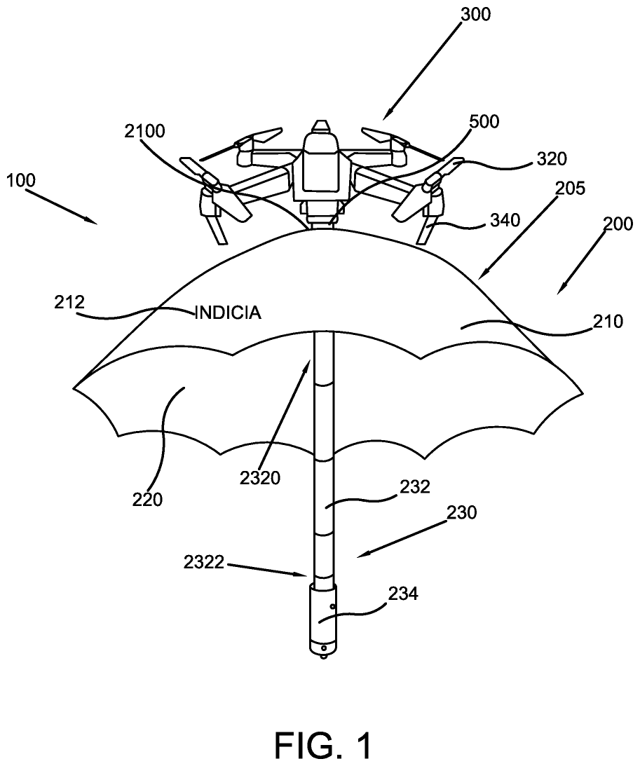

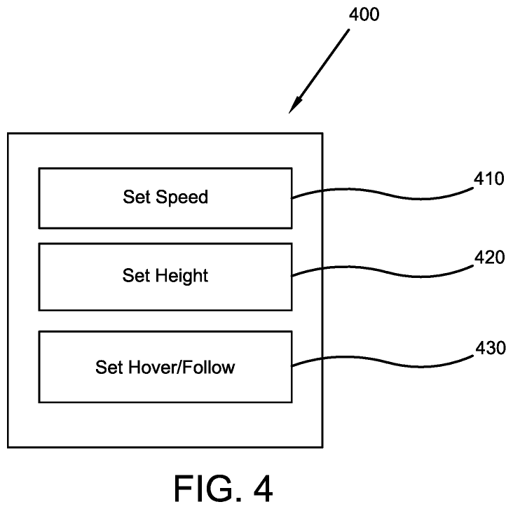

Referring initially to the drawings, FIG. 1 illustrates a perspective view of one embodiment of the drone umbrella device 100 of the present invention. The device 100 is primarily comprised of an umbrella 200, at least one drone 300 and a mobile application 400 (shown in FIG. 4). The umbrella 200 is comprised of a reinforced body 205 in the shape of a conventional umbrella and/or any other suitable umbrella shape as is known in the art. The reinforced body 205 material is preferably manufactured from a material such as, but not limited to, pongee, nylon, silk, acetate, rayon, etc., or any other suitable material as is known in the art. The reinforced body 205 material is also preferably waterproof and/or water resistant. The reinforced body 205 comprises an outer surface 210 and an inner surface 220. The outer surface 210 of the reinforced body 205 may comprise any number of indicia 212 such as, but not limited to, patterns, logos, emblems, images, symbols, designs, letters, words, characters, animals, advertisements, brands, etc., or any other suitable indicia as is known in the art.

The inner surface 220 of the reinforced body 205 comprises a handle assembly 230. The handle assembly 230 has a telescoping body 232 that is preferably manufactured from a durable rigid plastic or metal material, or any other suitable material as is known in the art. The telescoping body 232 comprises a first end 2320 and a second end 2322. The first end 2320 of the telescoping body 232 is fixedly or removably-attached to the inner surface 220 of the reinforced body 205 via a weld, threading, pin, spring connector, etc., or any other suitable fastener as is known in the art. The second end 2322 of the telescoping body 232 further comprises a handle 234. The handle 234 is shaped like a conventional umbrella handle as is known in the art and is preferably generally cylindrical, or any other suitable shape as is known in the art. The handle 234 can comprise an ergonomic gripping part, or other suitable gripping texture for a user's comforts. The handle 234 is also preferably manufactured from a rigid plastic or metal material, or any other suitable material as is known in the art. The handle 234 can also be detached from the second end 2322 of the telescoping body 232, which will be explained more fully below.

Furthermore, the outer surface 210 of the reinforced body 205 (and preferably the top-most portion 2100 of the outer surface 210) is comprised of at least one drone 300. In the preferred embodiment, the drone 300 is a quad-copter style drone that has four rotors 320, wherein each rotor 320 has at least one motor 340. However, in differing embodiments the at least one drone 300 can have any number of rotors 320 and motors 340, greater than one rotor 320 and one motor 340, and the drone 300 can be any suitable drone as is known in the art. The drone 300 is also fixedly or removably-attached to the outer surface 210 via at least one fastener 500. In differing embodiments, the fastener 500 may be any suitable fastener known in the art such as, but not limited to, a bolt, a screw, a string, an adhesive, a magnet, a tongue and groove, a buckle, etc. However, in one embodiment the drone 300 may be integrally formed (i.e., inseparable) to the umbrella 200.

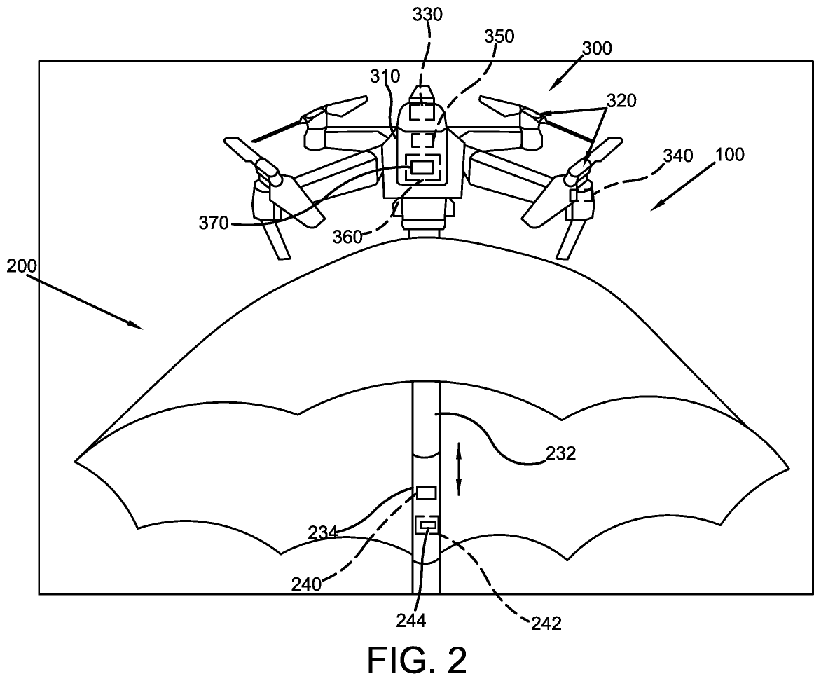

FIG. 2 discloses an embodiment of the drone umbrella device 100 of the present invention, wherein the telescoping body 232 is retracted upwards toward the umbrella 200. In this embodiment, the handle 234 is comprised of a GPS transmitter 240 and a battery 242. The battery 242 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the handle 234. Throughout this specification the term “battery” may be used interchangeably to refer to one or more wet or dry cells or batteries of cells in which chemical energy is converted into electricity and used as a source of DC power. References to recharging or replacing the battery 242 may refer to recharging or replacing individual cells, individual batteries of cells, or a package of multiple battery cells as is appropriate for any given battery technology that may be used. In addition, a rechargeable embodiment of the battery 242 may be recharged using a USB port 244, wherein the USB port 244 is a USB-A, USB-B, Micro-B, Micro-USB, Mini-USB, or USB-C port, etc.

Furthermore, the device 100 comprises at least one drone 300. In the preferred embodiment, the drone 300 is a quad-copter style drone that has four rotors 320, wherein each rotor 320 has at least one motor 340. However, in differing embodiments the at least one drone 300 can have any number of rotors 320 and motors 340, greater than one rotor 320 and one motor 340, or any other suitable drone 300 as is known in the art. The body 310 of the drone 300 is further waterproof and/or water-resistant and is made from a rigid plastic and/or metal material, or any other suitable material as is known in the art. The drone 300 is also fixedly or removably-attached to the umbrella 200 via at least one fastener 500. In differing embodiments, the fastener 500 may be any suitable fastener known in the art such as, but not limited to, a bolt, a screw, a string, an adhesive, a magnet, a tongue and groove, a buckle, etc. However, in one embodiment the drone 300 may be integrally formed to the umbrella 200.

The drone 300 is also comprised of a battery 360 that may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the drone 300. Throughout this specification the term “battery” may be used interchangeably to refer to one or more wet or dry cells or batteries of cells in which chemical energy is converted into electricity and used as a source of DC power. References to recharging or replacing the battery 360 may refer to recharging or replacing individual cells, individual batteries of cells, or a package of multiple battery cells as is appropriate for any given battery technology that may be used. In addition, a rechargeable embodiment of the battery 360 may be recharged using a USB port 370, wherein the USB port 370 is a USB-A, USB-B, Micro-B, Micro-USB, Mini-USB, or USB-C port, etc.

Furthermore, during use the drone 300 lifts the umbrella 200 off the ground, such that the umbrella 200 hovers over the top of a user (not shown). In order to maintain a position above the user as the user moves, the handle 234 must be detached from the telescoping body 232 and be retained by the user, such that the handle 234 moves with the user. As a user moves with the detached handle 234, a GPS transmitter 240 on the handle 234 communicates with a receiver 350 on the drone 300 via a communication means, such as but not limited to: RFID, Bluetooth, Cellular, Wi-Fi, etc. Accordingly, the drone will automatically position itself, such that it is directly above the GPS location of the handle 234 at all times.

A mobile application 400 (shown in FIG. 4) also allows a user to control various features of the drone 300 by communicating with a processor 330 within the drone 300 via RFID, Bluetooth, Cellular, Wi-Fi, etc. The application 400 allows a user to set the speed of the drone 300, which can be used to allow the drone 300 to more closely follow a user who is running or walking. A user can also set the height in which the drone 300 hovers over the handle 234 and/or user, to control the height of the device 100 in areas where the device 100 must fit under obstacles or is too close to the body of a user. Furthermore, a user can set the drone 300 to hover in a specific location and/or to follow the movement of the handle 234, such that the device 100 can remain hovering in a single location when a user is not moving or can follow above the user as the user moves. It should also be noted that the mobile application 400 can be used by the drone 300 to track the location of the user, to allow the drone 300 to follow the user in lieu of or in addition to the handle 234.

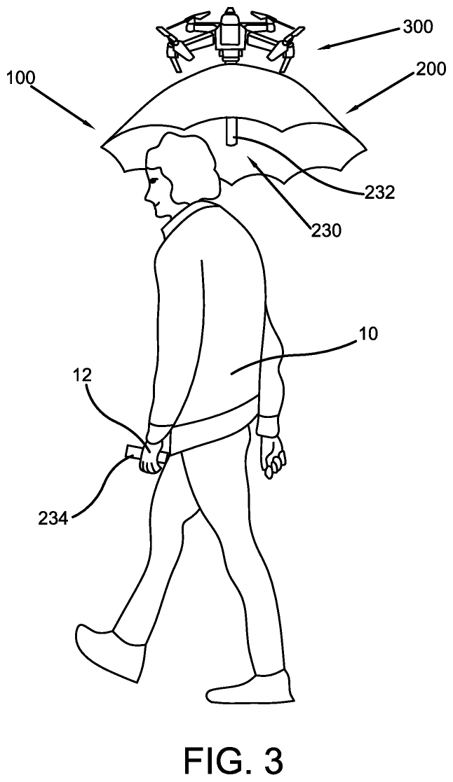

FIG. 3 illustrates a perspective view of one embodiment of the drone umbrella device 100 of the present invention in use. When using the device 100, the drone 300 lifts the umbrella 200 off the ground, such that the umbrella 200 hovers over the top of a user 10, typically the head, but any suitable position above the user 10 as is known in the art. The umbrella 200 further follows the user 10 and remains in a position above the user 10 as he or she walks, runs, stands or sits, etc. To maintain a position above the user 10, as the user 10 moves, a user must detach the handle 234 from the telescoping body 232 of the handle assembly 230. Then, the telescoping body 232 can be collapsed or retracted (i.e., telescoped) upwards toward the umbrella 200, as seen in FIG. 2, or can be left in an extended position based on a user's wants and/or needs. Next, the handle 234 is retained by the user 10, such as in his or her hand 12, in a pocket, in a bag or purse, etc., or any other suitable place as is known in the art, such that the handle 234 moves with the user 10. As a user 10 moves with the detached handle 234, the GPS transmitter 240 of the handle 234 communicates with a receiver 250 of the drone 300 via a communication means, such as but not limited to: RFID, Bluetooth, Cellular, Wi-Fi, etc. As a result, the drone 300 will position itself, such that it is directly above the GPS location of the handle 234.

FIG. 4 illustrates a graphical view of the primary functions of the mobile application 400 of the drone umbrella device 100 of the present invention. The device 100 may also be comprised of a mobile application 400 that can be used with any smart device. The mobile application 400 allows a user to control various features of the drone 300 by communicating with a processor 330 of the drone 300 via RFID, Bluetooth, Cellular, Wi-Fi, etc. One such feature is setting the speed 410 of the drone 300. This feature 410 can be used to allow the drone 300 to move more closely and follow a user 10 who is running or walking. This feature 410 may also allow a user to set the drone 300 to a run or walk mode that has an automatic, pre-set speed setting. Further, a user 10 can also set the height 420 in which the drone 300 hovers over the handle 234 and/or user 10. In this manner, a user 10 can control the height of the device 100 in areas where the device 100 must fit under obstacles. In addition, this feature 420 allows a user to ensure the device 100 is not hovering too close above his or her body. Furthermore, a user can set the drone 300 to hover in a specific geographic location and/or to follow the movement of the handle 234 with feature 430. In this manner, the device 100 can remain hovering in a single location when a user is not moving or can follow above a user 10 as the user 10 moves. In addition, the mobile application 400 can be used by the drone 300 to track the location of the user 10, to allow the drone 300 to follow the user 10 using the smart device with the mobile application 400 installed on it, in lieu of or in addition to, the handle 234.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drone umbrella device” and “device” are interchangeable and refer to the drone umbrella device 100 of the present invention.

Notwithstanding the forgoing, the drone umbrella device 100 of the present invention and its various components can be of any suitable size and configuration as is known in the art without affecting the overall concept of the invention, provided that they accomplish the above-stated objectives. One of ordinary skill in the art will appreciate that the size, configuration and material of the drone umbrella device 100 as shown in FIGS. 1-4 is for illustrative purposes only, and that many other sizes and shapes of the drone umbrella device 100 are well within the scope of the present disclosure. Although the dimensions of the drone umbrella device 100 are important design parameters for user convenience, the drone umbrella device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drone umbrella device comprising:
an umbrella further comprised of a telescoping handle assembly comprised of a handle with a GPS transmitter;
at least one drone further comprised of a receiver, wherein the at least one drone is attached to the umbrella; and
a mobile application that allows a user to configure a plurality of features of the at least one drone.

2. The drone umbrella device of claim 1, wherein the handle can be detached from the telescoping handle assembly.

3. The drone umbrella device of claim 2, wherein the GPS transmitter is in communication with the receiver.

4. The drone umbrella device of claim 3, wherein the handle can be retained by the user.

5. The drone umbrella device of claim 4, wherein the at least one drone hovers over a top of a GPS location created by the GPS transmitter of the handle to hover above the user as the user sits, runs, walks or stands.

6. A drone umbrella device comprising:
an umbrella comprised of a telescoping handle assembly further comprised of a detachable handle with a GPS transmitter and a battery with a USB port;
at least one drone attached to the umbrella, wherein the at least one drone is further comprised of a processor, a battery with a USB port, a receiver in communication with the GPS transmitter, at least one rotor, and at least one motor; and
a mobile application that allows a user to configure a plurality of features of the at least one drone.

7. The drone umbrella device of claim 6, wherein the detachable handle is retained by the user after being detached from the telescoping handle assembly.

8. The drone umbrella device of claim 7, wherein the at least one drone hovers over a top of a GPS location created by the GPS transmitter of the detachable handle to hover above the user as the user sits, runs, walks or stands.

9. The drone umbrella device of claim 6, wherein the mobile application allows the user to set a speed of the at least one drone, set a height of the at least one drone, and to set the at least one drone to hover in a specific location or to follow a movement of the detachable handle.

10. A drone umbrella device comprising:
a waterproof umbrella comprised of a telescoping handle assembly further comprised of a detachable handle with a GPS transmitter and a battery with a USB port;
at least one waterproof drone attached to the umbrella, wherein the at least one waterproof drone is further comprised of a processor, a battery with a USB port, a receiver in communication with the GPS transmitter, at least one rotor, and at least one motor; and
a mobile application for a smart device that allows a user to configure a plurality of features of the at least one waterproof drone.

11. The drone umbrella device of claim 10, wherein the detachable handle can be retained by the user after being detached from the telescoping handle assembly.

12. The drone umbrella device of claim 11, wherein the at least one waterproof drone hovers over a top of a GPS location created by the GPS transmitter of the detachable handle to hover above the user as the user sits, runs, walks or stands.

13. The drone umbrella device of claim 10, wherein the mobile application allows the user to set a speed of the at least one waterproof drone.

14. The drone umbrella device of claim 10, wherein the telescoping handle assembly can be fixedly or removably attached to an inner surface of the waterproof umbrella.

15. The drone umbrella device of claim 10, wherein the at least one waterproof drone is attached to an outer surface of the waterproof umbrella via at least one fastener.

16. The drone umbrella device of claim 10, wherein the at least one waterproof drone is integrally formed to an outer surface of the umbrella.

17. The drone umbrella device of claim 10, wherein the GPS transmitter communicates with the receiver via an RFID, a Bluetooth, a Cellular or a Wi-Fi connection.

18. The drone umbrella device of claim 10, wherein the mobile application allows the user to set a height of the at least one waterproof drone.

19. The drone umbrella device of claim 10, wherein the mobile application allows the user to set the at least one waterproof drone to hover in a specific location or to follow a movement of the detachable handle.

20. The drone umbrella device of claim 10, wherein the smart device that the mobile application is installed on can be used by the at least one waterproof drone to track a location of the user to allow the at least one waterproof drone to follow the user using the smart device instead of the GPS transmitter of the detachable handle.
